(19) United States
(12) Patent Application Publication
(10) Pub. No.: US 2011/0166857 A1
(43) Pub. Date: Jul. 7, 2011

(54) Human Voice Distinguishing Method and Device

(75) Inventors: Xiangyong Xie, Zhuhai (CN); Zhan Chen, Zhuhai (CN)

(73) Assignee: ACTIONS SEMICONDUCTOR CO. LTD., Zhuhai (CN)

(21) Appl. No.: 13/001,596

(22) PCT Filed: Sep. 15, 2009
(86) PCT No.: PCT/CN2009/001037

§ 371 Date: Dec. 27, 2010

(30) Foreign Application Priority Data
Sep. 26, 2008 (CN) 200810167142.1

(51) Int. Cl. G10L 15/00

(52) U.S. Cl. 704/238; 704/236; 704/E15.001

(57) ABSTRACT

A human voice distinguishing method and device are provided. The method involves: taking every n sampling points of the current frame of audio signals as one subsection, wherein n is a positive integer, judging whether two adjacent subsections have transition relative to a distinguishing threshold, wherein the sliding maximum absolute value of the two adjacent subsections is more and less than the distinguishing threshold respectively, if so, then determining the current frame to be human voice, where the sliding maximum absolute value of the subsection is obtained by the following method: taking the maximum value of absolute intensity of every sampling point in this subsection as the initial maximum absolute value of this subsection, and taking the maximum value of the initial maximum absolute value of this subsection and m subsections following this subsection as the sliding maximum absolute value of this subsection, wherein m is a positive integer.

### FIELD OF THE INVENTION

The present invention relates to the field of audio processing, and in particular to a method and device for discriminating human voice.

### BACKGROUND OF THE INVENTION

Human voice discrimination is to discriminate whether human voice is present in an audio signal. Human voice discrimination is typically carried out in a special environment with a special requirement. In the human voice discrimination, on one hand, it is not necessary to know what a speaker talks about but simply focus on whether there is anyone speaking, and on the other hand, human voice has to be discriminated in real time. Moreover, software and hardware overheads of a system have to be taken into account in order to reduce requirements in terms of software and hardware as could as possible.

Existing technologies of discriminating human voice are generally implemented in the following two manners. In a first manner, it is started with extracting a feature parameter of an audio signal, to detect human voice from the difference between the feature parameter of an audio signal with human voice and that of an audio signal without human voice. Feature parameters commonly used at present during the discrimination of human voice include, for example, an energy level, a rate of zero crossings, an autocorrelation coefficient, and an inverse spectrum. In a second manner, a feature is extracted from a linear predicative inverse spectrum coefficient or a Mel frequency inverse spectrum coefficient of an audio signal under the linguistic principle and then human voice is discriminated through matching against a template.

The existing technologies of discriminating human voice suffer from the following deficiencies:
1. The feature parameters such as an energy level, a rate of zero crossings, and an autocorrelation coefficient fail to well discriminate human voice from non-human voice, thus resulting in a poor detection effect; and
2. The method, in which a linear predicative inverse spectrum coefficient or an Mel frequency inverse spectrum coefficient is calculated and then human voice is discriminated through matching against a template, is so complicated that it involves a significant calculation workload and hence occupies excessive software and hardware resources, thus resulting in poor applicability.

### SUMMARY OF THE INVENTION

In view of this, embodiments of the invention propose a method and device for discriminating human voice which can accurately discriminate human voice in an audio signal with an insignificant calculation workload.

An embodiment of the invention proposes a method for discriminating human voice in an externally input audio signal, the method includes:
taking every n sampling points of a current frame of the audio signal as a segment, wherein n is a positive integer; and
determining in the current frame whether there are two adjacent segments with a transition with respect to a discrimination threshold and with the sliding maximum absolute values respectively above and below the discrimination threshold, and if there are two adjacent segments with the transition, determining the current frame as human voice;
wherein the sliding maximum absolute value of the segment is derived by:
taking the greatest one among absolute intensities of the sampling points in the segment as the initial maximum absolute value of the segment; and
taking the greatest one among the initial maximum absolute values of the segment and m segments succeeding the segment as the sliding maximum absolute value of the segment, where m is a positive integer.

An embodiment of the invention proposes a device for discriminating human voice in an externally input audio signal, the device includes:
a segmenting module configured to take every n sampling points of a current frame of the audio signal as a segment, where n is a positive integer;
a sliding maximum absolute value module configured to derive the sliding maximum absolute value of the segment by taking the greatest one among absolute intensities of the sampling points in the segment as the initial maximum absolute value of the segment and taking the greatest one among the initial maximum absolute values of the segment and m segments succeeding the segment as the sliding maximum absolute value of the segment, where m is a positive integer;
a transition determination module configured to determine in the current frame whether there are two adjacent segments with a transition with respect to a discrimination threshold and with the sliding maximum absolute values respectively above and below the discrimination threshold; and
a human voice discrimination module configured to determine the current frame as human voice when the transition determination module determines that the two adjacent segments with the transition are present.

It can be seen from the foregoing technical solutions, human voice can be discriminated from non-human voice by a transition of the sliding maximum absolute value of the audio signal with respect to the discrimination threshold to thereby reflect well the features of human voice and non-human voice with an insignificant calculation workload and storage space as required.

### BRIEF DESCRIPTION OF THE DRAWINGS

FIG. 1 illustrates an example of a waveform of pure human voice in the time domain;

FIG. 2 illustrates an example of a waveform of pure music in the time domain;

FIG. 3 illustrates an example of a waveform of pop music with human singing in the time domain;

FIG. 4 illustrates a sliding maximum absolute value curve into which the pure human voice illustrated in FIG. 1 is converted;

FIG. 5 illustrates a sliding maximum absolute value curve into which the pure music illustrated in FIG. 2 is converted;

FIG. 6 illustrates a sliding maximum absolute value curve into which the pop music with human singing illustrated in FIG. 3 is converted;

FIG. 7 illustrates a waveform of a segment of broadcast programme recording in the time domain;

FIG. 8 illustrates a sliding maximum absolute value curve into which the waveform in the time domain illustrated in FIG. 7 is converted, where a discrimination threshold is included;

FIG. 9 illustrates a flow chart of discriminating human voice according to an embodiment of the invention;

FIG. 10 illustrates a diagram of a typical relationship between a sliding maximum absolute value of human voice and a discrimination threshold;

FIG. 11 illustrates a diagram of a typical relationship between a sliding maximum absolute value of non-human voice and a discrimination threshold; and

FIG. 12 illustrates a schematic diagram of modules in a device for discriminating human voice according to an embodiment of the invention.

### DETAILED DESCRIPTION OF THE EMBODIMENTS

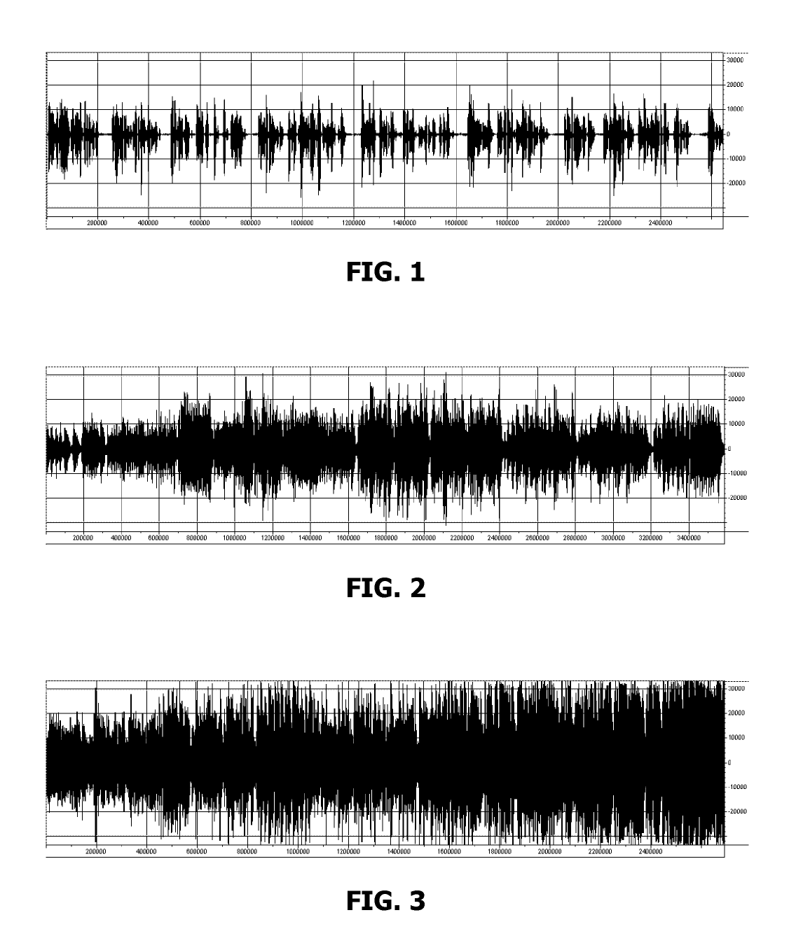

The underlying principle of the solution according to the invention will be introduced before embodiments of the invention are described. FIGS. 1-3 illustrate examples of three waveform diagrams in the time domain, in which the abscissa represents the index of a sampling point of an audio signal, and the ordinate represents the intensity of the sampling point of the audio signal, with the sampling rate being 44100 which is also adopted in subsequent schematic diagrams. FIG. 1 illustrates a waveform diagram of pure human voice in the time domain, FIG. 2 illustrates a waveform diagram of pure music in the time domain, and FIG. 3 illustrates a waveform diagram of pop music with human singing in the time domain, which may be regarded as the effect of superimposing human voice over music. The human voice discrimination technology is to determine whether human voice is present in an audio signal, and it is determined that human voice is not included in such an audio signal that is presented as the effect of superimposing human voice over music.

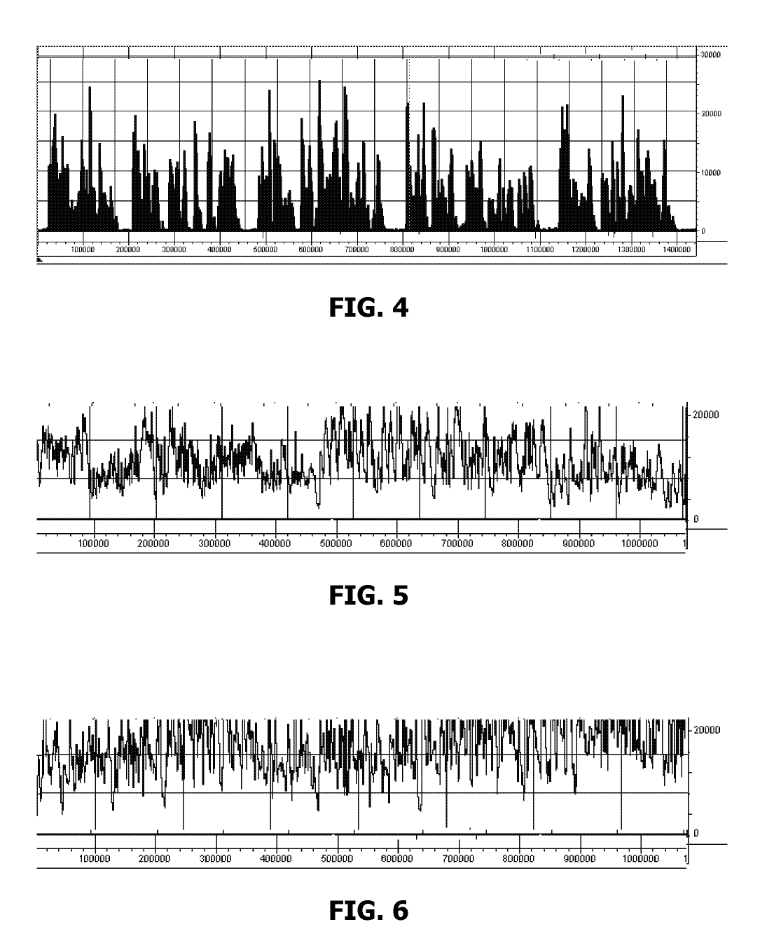

As can be apparent from features of the waveforms in FIGS. 1-3, the diagram of human voice in the time domain differs significantly from that of non-human voice in the time domain. Typically, a person speaks with cadences, and the acoustic intensity of human voice is rather weak at a pause between syllables, which results in a sharp variation of the image in the waveform diagram in the time domain, but such a typical feature is absent with non-human voice. In order to present the foregoing feature of human voice more apparently, the waveforms in FIGS. 1-3 are converted into sliding maximum absolute value curve diagrams as illustrated in FIGS. 4-6, respectively, in which the abscissa represents the index of the sampling point of the audio signal, and the ordinate represents the sliding maximum absolute intensity (i.e., the sliding maximum absolute value) of the sampling point of the audio signal. The greatest one among the absolute intensities (i.e., the absolute values of intensities) of m consecutive sampling points of the audio signal is taken as the sliding maximum absolute value of the first one among the m consecutive sampling points of the audio signal, where m is a positive integer and referred to as a sliding length. It can be seen that the significant difference of FIG. 4 from FIG. 5 or FIG. 6 lies in whether a zero value occurs in the curve, because the zero value occurs in the sliding maximum absolute value curve for the waveform feature of human voice but does not occur with non-human voice, e.g., music. Further, for a segment of audio signal which includes n consecutive sampling points, it is possible that the absolute intensity of the segment of audio signal is represented by the greatest one among the absolute intensities of the sampling points in the segment, and the sliding maximum absolute value of the segment of audio signal is represented by the greatest one among the absolute intensities of the segment and m consecutive segments succeeding the segment, where both n and m are positive integers. Therefore, the sliding maximum absolute value curve may have its abscissa representing the indexes of segments of audio signal into which the sampling points are grouped and ordinate representing the sliding maximum absolute value of each of the segments of audio signal. In the examples of FIGS. 4-6, each segment consists of one sampling point, that is, n=1.

The solution according to the invention carries out the discrimination of human voice with use of such feature of human voice that a zero value is present in sliding maximum absolute value curve of the human voice. However, in a practical application, a person usually speaks in an environment which is not absolutely silent but more or less accompanied by non-human voice. Therefore, an appropriate discrimination threshold is required, and the crossing of the sliding maximum absolute value curve over the discrimination threshold curve indicates presence of human voice.

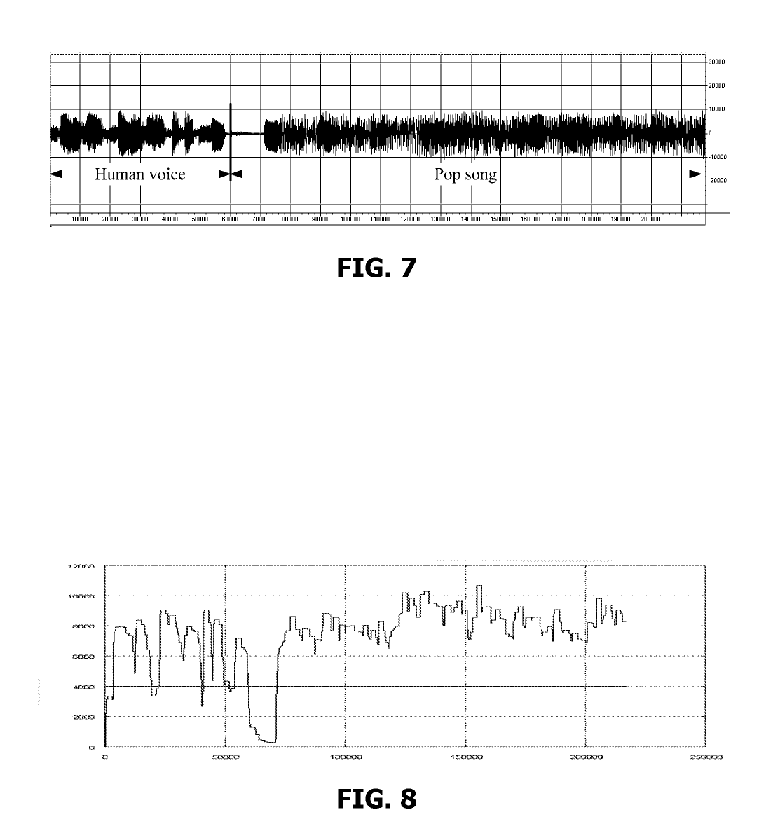

FIG. 7 illustrates a waveform diagram of a segment of broadcast programme recording in the time domain, where the leading part of the segment represents a DJ speaking, and the succeeding part of the segment represents a played pop song, with a corresponding sliding maximum absolute value curve being illustrated in FIG. 8. The abscissas in FIGS. 7 and 8 represent the index of a sampling point of an audio signal, the ordinate in FIG. 7 represents the intensity of the sampling point of the audio signal, and the ordinate in FIG. 8 represents the sliding maximum absolute value of the sampling point of the audio signal. Human voice may be discriminated from non-human voice by an appropriate selected discrimination threshold. The horizontal solid line in FIG. 8 represents a discrimination threshold. The sliding maximum absolute value curve may intersect with the horizontal solid line in the part representing the DJ speaking but not in the part representing the played pop song. In the context of the present application, an intersection of the sliding maximum absolute value curve with the discrimination threshold line is referred to as an transition of the sliding maximum absolute value with respect to the discrimination threshold, or simply referred to as an transition, and the number of the intersection of the sliding maximum absolute value curve with the discrimination threshold line is referred to as a transition number. It shall be noted that the discrimination threshold in FIG. 8 is constant, but in a practical application, the discrimination threshold may be adjusted dynamically depending on the intensity of the audio signal.

According to a first embodiment of the invention, a method for discriminating human voice in an externally input audio signal includes:
every n sampling points of a current frame of the audio signal are grouped as a segment, where n is a positive integer; and
it is determined in the current frame whether there are two adjacent segments with a transition across a discrimination threshold, with the sliding maximum absolute values of the two adjacent segments respectively being above and below the discrimination threshold, and if so, the current frame is determined as being from human voice.

In the method, the sliding maximum absolute value of the segment is derived by the following manner:
the greatest one among the absolute intensities of the sampling points in the segment is taken as the initial maximum absolute value of the segment; and
the greatest one among the initial maximum absolute values of the segment and m segments succeeding the segment is take as the sliding maximum absolute value of the segment, where m is a positive integer.

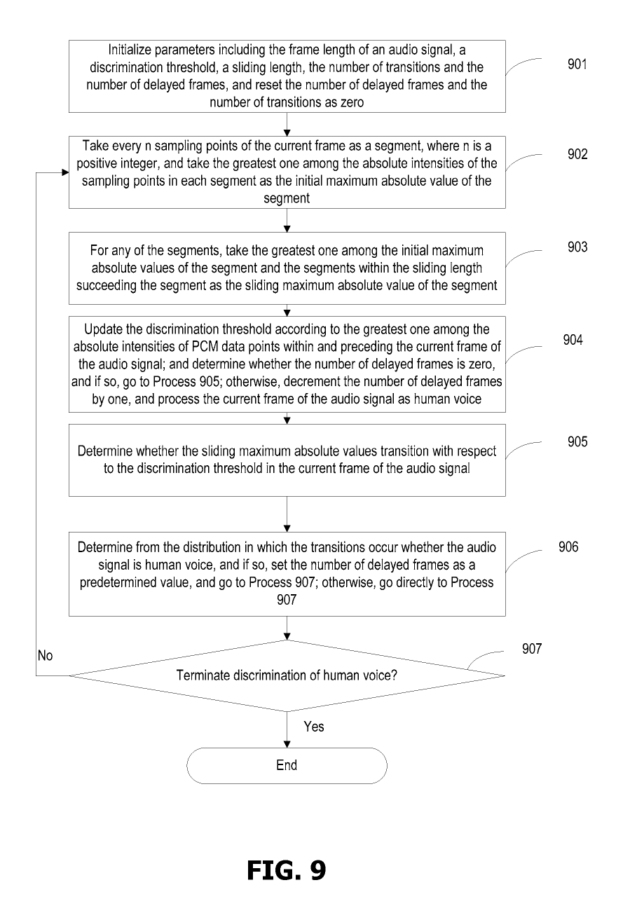

As illustrated in FIG. 9, a specific flow of the discrimination of human voice according to a second embodiment of the invention includes the following processes 901-907.

Process 901: Parameters are initialized. The initialized parameters may include the frame length of an audio signal, a discrimination threshold, a sliding length, the number of transitions and the number of delayed frames, where the number of delayed frames and the number of transitions may have an initial value of zero.

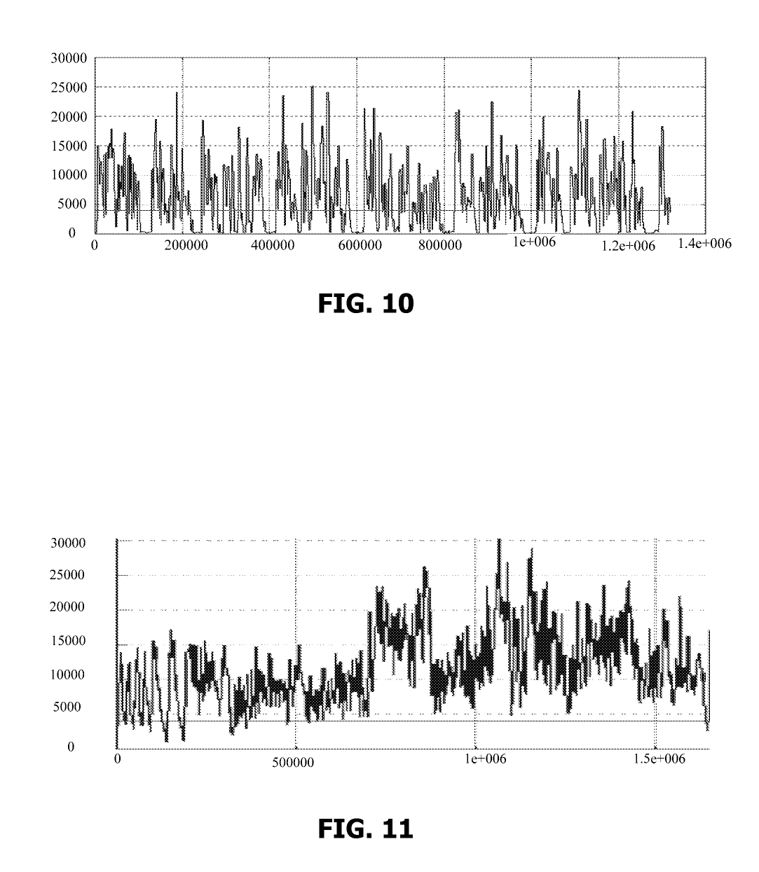

The discrimination threshold may be selected as one Kth of the greatest one among the absolute intensities of Pulse Code Modulation (PCM) data points (i.e., sampling points of the audio signal) within and preceding the current frame of the audio signal, where K is a positive number. Different K may result in a different discrimination capability, thus preferably K=8 which may result in a satisfactory effect. It is found experimentally that transition may occur for non-human voice with respect to the discrimination threshold. FIG. 10 illustrates a diagram of typical relationship between a sliding maximum absolute value of human voice and a discrimination threshold, and FIG. 11 illustrates a diagram of typical relationship between a sliding maximum absolute value of non-human voice and a discrimination threshold, where both of the abscissas in FIGS. 10 and 11 represent the index of a sampling point and the ordinates represent the sliding maximum absolute value of the sampling point. It can be found that the distribution feature of the transitions of human voice differs from that of non-human voice in that there is a large interval of time between two adjacent transitions of the human voice and a small interval of time between two adjacent transitions of the non-human voice. Therefore, in order to further avoid incorrect discrimination, an interval of time between two adjacent transitions may be referred to as a transition length, and when a transition occurs with a transition length above a preset transition length, the current frame is determined as human voice.

The solution according to the invention is applicable to a scenario with real time processing. After the current audio signal is discriminated, the current audio signal cannot be processed because the current audio signal has been played, and instead an audio signal succeeding the current audio signal will be processed. Since a person speaks with certain coherence, the number k of delayed frames may be set so that after the current frame is determined as human voice, an audio signal of k consecutive frames succeeding the current frame may be determined directly as human voice, thus the k frames are processed as human voice, where k is a positive integer, e.g., 5. Thus, human voice in the audio signal can be processed in real time.

Process 902: Every n sampling points of the current frame are taken as a segment, where n is a positive integer, and the greatest one among the absolute intensities of the sampling points in each segment is taken as the initial maximum absolute value of the segment.

At present, a common audio sampling rate for the pop music, etc., is 44100, that is, the number of sampling points per second is 44100, and the parameter n may be as adapted to the various sampling rates. The following description is given by taking the sampling rate of 44100 as an example. If the sliding maximum absolute value of each sampling point is taken, an excessively large space will be occupied. For example, if the frame length is 4096 and the sliding length is selected as 2048, 4096+2048 storage units are needed to store the data, and apparently the number of occupied storage units is excessively large. The inventors have identified experimentally that a satisfactory effect can be attained at a resolution of 256 sampling points. Therefore, n may preferably take a value of 256 while the sliding length is still 2048, then a frame includes 16 segments, and the sliding length involves 8 segments, thus resulting in a need of only 16+8=24 storage units.

Process 903: For any of the segments, the greatest one among the initial maximum absolute values of the segment and the segments within the sliding length succeeding the segment is taken as the sliding maximum absolute value of the segment.

For example, the greatest one among the initial maximum absolute values of the segments 1-9 is taken as the sliding maximum absolute value of the segment 1, the greatest one among the initial maximum absolute values of the segments 2-10 is taken as the sliding maximum absolute value of the segment 2, and so on.

Process 904: The discrimination threshold is updated according to the greatest one among the absolute intensities of PCM data points within and preceding the current frame of the audio signal; and it is determined whether the number of delayed frames is zero, and if the number of delayed frames is zero, the flow goes to Process 905; if the number of delayed frames is not zero, the number of delayed frames is decremented by one, and the current frame of the audio signal is processed as human voice, e.g., muted, depending upon a specific application.

After processing the audio signal in the number of delayed frames as human voice, the flow may go to the Process 902 to proceed with the process of discriminating whether the next frame is human voice (not illustrated).

Process 905: It is determined, according to the sliding maximum absolute values of the segments in the current frame of the audio signal and the discrimination threshold, whether the sliding maximum absolute values transit across the discrimination threshold in the current frame of the audio signal. Specifically, the sliding maximum absolute values of the segments in the current frame other than the first segment may be processed respectively as follows:
a product of (The sliding maximum absolute value of the current segment−The discrimination threshold)×(The sliding maximum absolute value of the preceding segment−The discrimination threshold) is obtained; and
it is determined whether the product is below zero, and if the product is below zero, a transition has occurred, and the number of transitions is incremented by one; otherwise, no transition has occurred.

Process 906: It is determined, from the distribution in which the transitions occur, whether the audio signal is human voice.

The Process 906 may include: It is determined whether the density of transitions and the length of transition satisfy predefined requirements. The density of transitions refers to the number of transitions occurring per unit of time. The density of transitions up to the current period of time is counted and checked for compliance with a predetermined criterion. The predetermined criterion includes, for example, the maximum and minimum densities of transitions, that is, prescribed upper and lower limits of the density of transitions. The predetermined criterion may be derived from training a standard human voice signal. If the density of transitions is below the upper limit and above the lower limit, and the length of transition is above a length-of-transition criterion, the current frame of the audio signal is human voice; otherwise, the current frame of the audio signal is not human voice.

If the current frame of the audio signal is determined as human voice, the number of delayed frames is set as a predetermined value, and the flow goes to Process 907. If the current frame of the audio signal is determined as non-human voice, the flow goes directly to the Process 907.

Process 907: It is determined whether to terminate discrimination of human voice, and if so, the flow ends; otherwise, the flow goes to the Process 902 to proceed with the process of discriminating whether the next frame is human voice.

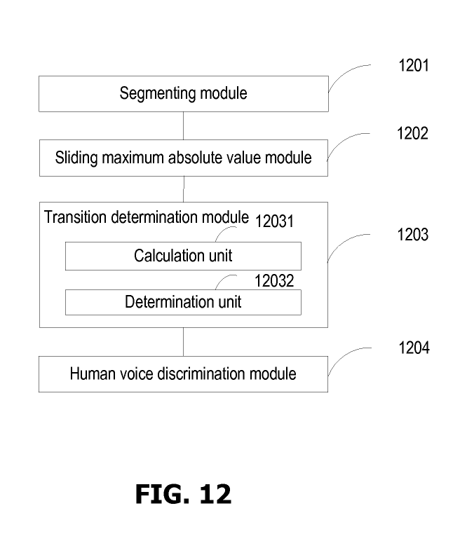

As illustrated in FIG. 12, an embodiment of the invention further proposes a device for discriminating human voice including:
a segmenting module 1201 configured to take every n sampling points of a current frame of an audio signal as a segment, where n is a positive integer;
a sliding maximum absolute value module 1202 configured to derive the sliding maximum absolute value of the segment, where the sliding maximum absolute value of any of the segments is derived by taking the greatest one among the absolute intensities of the sampling points in the segment as the initial maximum absolute value of the segment and taking the greatest one among the initial maximum absolute values of the segment and m segments succeeding the segment as the sliding maximum absolute value of the segment, where m is a positive integer;
a transition determination module 1203 configured to determine in the current frame whether there are two adjacent segments with a transition with respect to a discrimination threshold and with the sliding maximum absolute values respectively above and below the discrimination threshold; and
a human voice discrimination module 1204 configured to determine the current frame as human voice when the transition determination module determines there are two adjacent segments with a transition.

In a further embodiment of the device for discriminating human voice according to the invention, the device for discriminating human voice further includes a number-of-transition determination module configured to determine whether the number of transitions occurring with adjacent segments in the current frame per unit of time is within a preset range, and the human voice discrimination module is configured to determine the current frame as human voice when both determination results of the transition determination module and the number-of-transition determination module are positive.

In a further embodiment of the device for discriminating human voice according to the invention, the device for discriminating human voice further includes a transition interval determination module configured to determine whether the interval of time between two adjacent transitions in the current frame is above a preset value, and the human voice discrimination module is configured to determine the current frame as human voice when both determination results of the transition determination module and the transition interval determination module are positive.

In a further embodiment of the device for discriminating human voice according to the invention, the transition determination module 1203 includes:
a calculation unit 12031 configured to calculate the difference between the sliding maximum absolute value of each of the segments in the current frame other than the first segment and the discrimination threshold and the difference between the sliding maximum absolute value of a preceding segment to the segment and the discrimination threshold and to calculate the product of the two differences; and
a determination unit 12032 configured to determine whether the current frame includes at least one segment for which the calculated product is below zero, and if so, to determine that two adjacent segments with a transition are present; otherwise, to determine that two adjacent segments with a transition are not present.

The human voice discrimination module 1204 is further configured to determine directly k frames succeeding the current frame as human voice after determining the current frame as human voice, where k is a preset positive integer.

Those skilled in the art can clearly appreciate from the foregoing description of the embodiments that the invention can be embodied in software plus a requisite hardware platform or, of course, totally in hardware, although the former may be preferred in many cases. Based upon such understanding, all or a part of the technical solution according to the invention contributing to the prior art can be embodied in the form of a software product, which can be stored in a storage medium, e.g., an ROM/RAM, a magnetic disk, an optical disk, and which can include several instructions causing a computer device (e.g., a personal computer, a portal media player or any other electronic product capable of media playing) to perform the method according to the embodiments of the invention or some parts thereof.

The embodiments of the invention propose a set of solutions to discrimination of human voice applicable to a portal multimedia player and with an insignificant calculation workload and storage space as required. In the solution according to the embodiments of the invention, the data in the time domain is used for obtaining the sliding maximum value to thereby reflect well the features of human voice and non-human voice, and the use of the discrimination criterion of transition can avoid well the problem of inconsistent criterions due to different volumes.

The foregoing descriptions are merely illustrative of the preferred embodiments of the invention but not intended to limit the invention. Any modifications, equivalent substitutions and adaptations made without departing from the scope of the invention shall be involved in the scope of the invention.

1. A method for discriminating human voice in an externally input audio signal, comprising:
taking every n sampling points of a current frame of the audio signal as a segment, wherein n is a positive integer; and
determining in the current frame whether there are two adjacent segments with a transition with respect to a discrimination threshold, with the sliding maximum absolute values of the two adjacent segments being respectively above and below the discrimination threshold, and if there are two adjacent segments with the transition, determining the current frame as human voice,
wherein the sliding maximum absolute value of the segment is derived by:
taking the greatest one among absolute intensities of the sampling points in the segment as the initial maximum absolute value of the segment; and
taking the greatest one among the initial maximum absolute values of the segment and m segments succeeding the segment as the sliding maximum absolute value of the segment, wherein m is a positive integer.

2. The method for discriminating human voice according to claim 1, wherein determining the current frame as human voice comprises:
determining whether the number of transitions occurring with adjacent segments in the current frame per unit of time is within a preset range, and if the number of transitions is within the preset range, determining the current frame as human voice.

3. The method for discriminating human voice according to claim 1, wherein determining the current frame as human voice comprises:
determining whether an interval of time between two adjacent transitions in the current frame is above a preset value, and if the interval of time is above the preset value, determining the current frame as human voice.

4. The method for discriminating human voice according to claim 1, wherein n takes a value of 256 when a sampling rate of the audio signal is 44100.

5. The method for discriminating human voice according to claim 1, wherein determining in the current frame whether there are two adjacent segments with a transition with respect to the discrimination threshold comprises:
calculating a difference between the sliding maximum absolute value of each of the segments in the current frame other than the first segment and the discrimination threshold and a difference between the sliding maximum absolute value of a preceding segment to the segment and the discrimination threshold, and calculating the product of the two differences; and
determining whether the current frame comprises at least one segment for which the calculated product is below zero, and if so, determining that the two adjacent segments with a transition are present; otherwise, determining the two adjacent segments with a transition are not present.

6. The method for discriminating human voice according to claim 1, wherein the discrimination threshold of each frame of the audio signal is a constant value.

7. The method for discriminating human voice according to claim 1, wherein the discrimination threshold of each frame of the audio signal is adjustable.

8. The method for discriminating human voice according to claim 1, wherein the discrimination threshold of the current frame is one Kth of the greatest one among absolute intensities of sampling points within and preceding the current frame, wherein K is a positive number.

9. The method for discriminating human voice according to claim 8, wherein K is equal to 8.

10. The method for discriminating human voice according to claim 1, further comprising after determining the current frame as human voice, determining k frames succeeding the current frame as human voice, wherein k is a preset positive integer.

11. A device for discriminating human voice in an externally input audio signal, comprising:
a segmenting module configured to take every n sampling points of a current frame of the audio signal as a segment, wherein n is a positive integer;
a sliding maximum absolute value module configured to derive the sliding maximum absolute value of the segment by taking the greatest one among absolute intensities of the sampling points in the segment as the initial maximum absolute value of the segment and taking the greatest one among the initial maximum absolute values of the segment and m segments succeeding the segment as the sliding maximum absolute value of the segment, wherein m is a positive integer;
a transition determination module configured to determine in the current frame whether there are two adjacent segments with a transition with respect to a discrimination threshold and with the sliding maximum absolute values respectively above and below the discrimination threshold; and
a human voice discrimination module configured to determine the current frame as human voice when the transition determination module determines that the two adjacent segments with the transition are present.

12. The device for discriminating human voice according to claim 11, further comprising a number-of-transition determination module configured to determine whether the number of transitions occurring with adjacent segments in the current frame per unit of time is within a preset range, and wherein the human voice discrimination module is configured to determine the current frame as human voice when both determination results of the transition determination module and the number-of-transition determination module are positive.

13. The device for discriminating human voice according to claim 11, further comprising a transition interval determination module configured to determine whether an interval of time between two adjacent segments in the current frame is above a preset value, and wherein the human voice discrimination module is configured to determine the current frame as human voice when both determination results of the transition determination module and the transition interval determination module are positive.

14. The device for discriminating human voice according to claim 11, wherein the transition determination module comprises:
a calculation unit configured to calculate a difference between the sliding maximum absolute value of each of the segments in the current frame other than the first segment and the discrimination threshold and a difference between the sliding maximum absolute value of the preceding segment to the segment and the discrimination threshold and to calculate the product of the two differences; and
a determination unit configured to determine whether the current frame comprises at least one segment for which the calculated product is below zero, and if so, to determine that the two adjacent segments with the transition are present; otherwise, to determine that the two adjacent segments with the transition are not present.

15. The device for discriminating human voice according to claim 11, wherein the human voice discrimination module is further configured to determine directly k frames succeeding the current frame as human voice after determining the current frame as human voice, wherein k is a preset positive integer.
